(19) United States
(12) Patent Application Publication
(10) Pub. No.: US 2025/0299300 A1
(43) Pub. Date: Sep. 25, 2025

(54) IMAGE PROCESSING DEVICE

(71) Applicant: SUBARU CORPORATION, Tokyo (JP)

(72) Inventor: Masahiro SHIRAKI, Tokyo (JP)

(73) Assignee: SUBARU CORPORATION, Tokyo (JP)

(21) Appl. No.: 19/077,423

(22) Filed: Mar. 12, 2025

Related U.S. Application Data
(63) Continuation of application No. PCT/JP2024/011500, filed on Mar. 22, 2024.

(51) Int. Cl. G06T 5/50; G06T 5/20

(52) U.S. Cl. CPC G06T 5/50; G06T 5/20; G06T 2207/10012

(57) ABSTRACT

An image processing device includes a processing circuit configured to generate a distance image by performing filtering on each of a left image and a right image with a filter pattern having four-fold rotational symmetry and stereo matching. The filter pattern includes first filter coefficients and second filter coefficients provided in a first region and a second region respectively. Each first filter coefficient has a value of a first polarity, and each second filter coefficient has a value of a second polarity different from the first polarity. One of the first filter coefficients having the largest absolute value is provided at a middle of the first region. The second filter coefficients include two or more filter coefficients having respective values different from each other. The second filter coefficients include four corner filter coefficients and each have an absolute value larger than an absolute value of an adjacent filter coefficient.

### CROSS-REFERENCE TO RELATED APPLICATION

This application is continuation of International Application No. PCT/JP2024/011500, filed on Mar. 22, 2024, the entire contents of which are hereby incorporated by reference.

### BACKGROUND

The disclosure relates to an image processing device that performs filtering on each of a left image and a right image.

In vehicles, stereo matching is often performed based on a left image and a right image that are generated by a stereo camera, and driving assistance is performed based on processing results of the stereo matching. An image may include various noises, and hence such noises are reduced. For example, Japanese Unexamined Patent Application Publication (JP-A) No. 2009-100150 discloses a technology of reducing noises such as zipper artifact included in the image.

### SUMMARY

A first image processing device according to one embodiment of the disclosure includes a processing circuit. The processing circuit is configured to perform filtering on each of a left image and a right image with the use of a filter pattern set in advance, and is configured to generate a distance image by performing stereo matching based on the left image and the right image that have been subjected to the filtering. The filter pattern includes a plurality of first filter coefficients provided in a first region and a plurality of second filter coefficients provided in a second region disposed around the first region. The first filter coefficients each have a value of a first polarity, and the second filter coefficients each have a value of a second polarity different from the first polarity. One of the first filter coefficients having the largest absolute value is provided at a middle of the first region. The second filter coefficients include two or more filter coefficients having respective values different from each other. The second filter coefficients include four corner filter coefficients positioned at four corners of the filter pattern, and each of the corner filter coefficients has an absolute value larger than an absolute value of an adjacent filter coefficient in the filter pattern. The filter pattern is a pattern having four-fold rotational symmetry.

A second image processing device according to one embodiment of the disclosure includes a processing circuit. The processing circuit is configured to perform filtering on each of a left image and a right image with the use of a filter pattern set in advance, and is configured to generate a distance image by performing stereo matching based on the left image and the right image that have been subjected to the filtering. The filter pattern includes a plurality of first filter coefficients provided in a first region and a plurality of second filter coefficients provided in a second region disposed around the first region. The first filter coefficients each have a value of a first polarity, and the second filter coefficients each have a value of a second polarity different from the first polarity. One of the first filter coefficients having the largest absolute value is provided at a middle of the first region. The second filter coefficients include two or more filter coefficients having respective values different from each other. The second filter coefficients include four middle filter coefficients positioned at middles of four sides of the filter pattern, and each of the middle filter coefficients has an absolute value larger than an absolute value of an adjacent second filter coefficient in the filter pattern. The filter pattern is a pattern having four-fold rotational symmetry.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory view illustrating one configuration example of a vehicle including a driving assistance device according to one embodiment of the disclosure;

FIG. 2 is a block diagram illustrating one configuration example of the driving assistance device illustrated in FIG. 1;

FIG. 3 is an explanatory view illustrating one example of a pixel array in an image sensor of a stereo camera illustrated in FIG. 2;

FIG. 4 is an explanatory view illustrating one example of a left image and a right image illustrated in FIG. 2;

FIG. 5 is an explanatory view illustrating one example of a zipper noise;

FIG. 6 is an explanatory view illustrating one configuration example of a filter pattern to be used by a filtering processor illustrated in FIG. 2;

FIG. 7 is an explanatory view illustrating a creation example of the filter pattern illustrated in FIG. 6;

FIG. 8 is another explanatory view illustrating the creation example of the filter pattern illustrated in FIG. 6;

FIG. 9 is another explanatory view illustrating the creation example of the filter pattern illustrated in FIG. 6;

FIG. 10 is an explanatory view illustrating one example of a processing target image to be subjected to filtering by the filtering processor illustrated in FIG. 2;

FIG. 11A is an explanatory view illustrating one example of filtering performed in the filtering processor illustrated in FIG. 2;

FIG. 11B is an explanatory view illustrating one example of filtering performed in the filtering processor illustrated in FIG. 2;

FIG. 12A is an explanatory view illustrating one example of filtering according to a reference example;

FIG. 12B is an explanatory view illustrating one example of filtering according to the reference example;

FIG. 13A is an explanatory view illustrating one example of filtering according to another reference example;

FIG. 13B is an explanatory view illustrating one example of filtering according to the other reference example;

FIG. 14 is an explanatory graph illustrating one example of a traveling speed of a proceeding vehicle estimated by the driving assistance device illustrated in FIG. 2; and

FIG. 15 is an explanatory graph illustrating one example of a traveling speed of a proceeding vehicle estimated by the driving assistance device according to another reference example.

### DETAILED DESCRIPTION

The accompanying drawings are included to provide a further understanding of the disclosure, and are incorporated in and constitute a part of the present specification. The drawings illustrate one embodiment and, together with the specification, serve to explain the principles of the disclosure.

When stereo matching is performed based on a left image and a right image, noises included in the left image and the right image may reduce accuracy of the stereo matching. Thus, it is expected to suppress reduction in accuracy of the stereo matching.

It is desirable to provide an image processing device capable of suppressing reduction in accuracy of stereo matching.

In the following, some exemplary embodiments of the disclosure are described in detail with reference to the accompanying drawings. It is to be noted that the following description is directed to illustrative examples of the disclosure and may not be construed as limiting the disclosure. Factors including, for example, numerical values, shapes, materials, components, positions of the components, and how the components are coupled to each other are illustrative and may not be construed as limiting the disclosure. Further, in the following exemplary embodiments, elements that are not recited in the aspect that is based on the highest concept of the disclosure are optional and may be provided on an as-needed basis. The drawings may be schematic and may not be intended to be drawn to scale. Throughout the present specification and the drawings, elements having substantially the same function and configuration are denoted with the same reference numerals to avoid any redundant description. Further, elements that are not directly related to any embodiment of the disclosure are unillustrated in the drawings.

### Embodiment

### Configuration Example

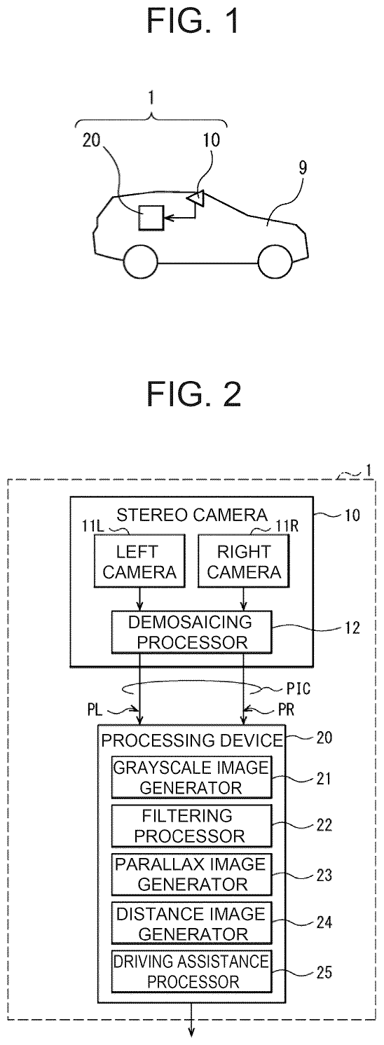

FIG. 1 and FIG. 2 illustrate one configuration example of a driving assistance device 1 including an image processing device according to one embodiment. The driving assistance device 1 is mounted on a vehicle 9, and is configured to assist the driving of the vehicle 9 performed by a driver who drives the vehicle 9. The driving assistance device 1 includes a stereo camera 10 and a processing device 20.

The stereo camera 10 is configured to image a front side of the vehicle 9 to generate data of a pair of images having parallax. The stereo camera 10 includes a left camera 11L, a right camera 11R, and a demosaicing processor 12. The left camera 11L and the right camera 11R each include a lens and an image sensor.

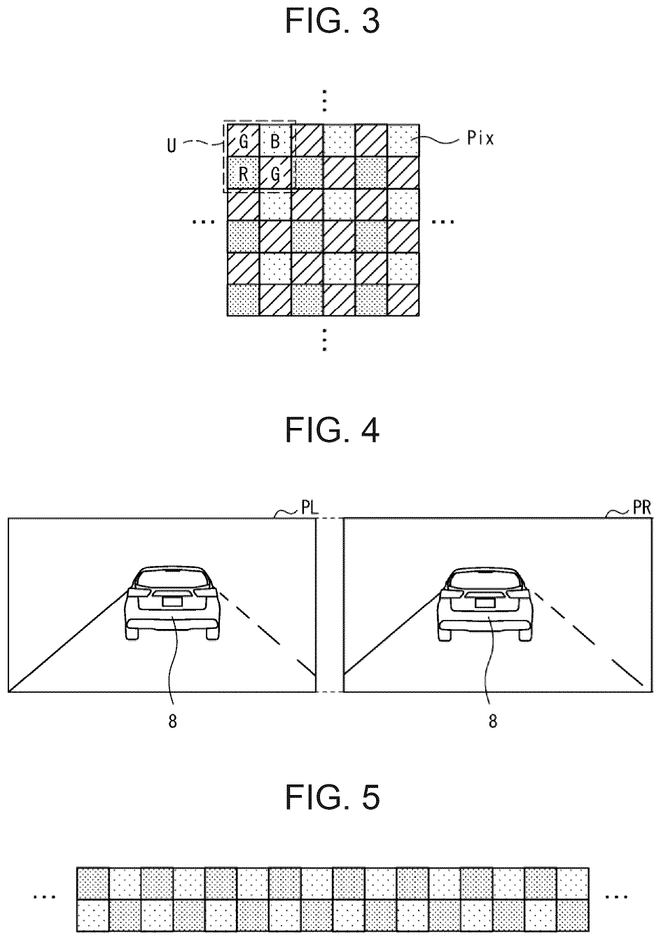

FIG. 3 illustrates one example of a pixel array in the image sensor of the stereo camera 10. The image sensor includes a plurality of pixels Pix disposed side by side. The pixels Pix include a pixel Pix that can detect light of red (R), a pixel Pix that can detect light of green (G), and a pixel Pix that can detect light of blue (B). The pixels Pix are disposed in a unit U of four (=2×2) pixels Pix disposed in two rows and two columns. In this example, in the unit U, the pixel Pix that can detect light of red (R) is disposed at the lower left, the pixel Pix that can detect light of green (G) is disposed at each of the upper left and the lower right, and the pixel Pix that can detect light of blue (B) is disposed at the upper right. This pixel array is also called a Bayer array.

In this example, as illustrated in FIG. 1, the stereo camera 10 is disposed inside of the vehicle 9 in the vicinity of an upper portion of a windshield of the vehicle 9. The left camera 11L and the right camera 11R of the stereo camera 10 are disposed so as to be spaced apart by a predetermined distance in a width direction of the vehicle 9. The left camera 11L generates a left image, and the right camera 11R generates a right image.

The demosaicing processor 12 is configured to perform demosaicing on each of the left image supplied from the left camera 11L and the right image supplied from the right camera 11R. In the image sensor in which the pixels Pix are disposed in a Bayer array, the pixel Pix that can detect light of red (R) is provided, for example, as illustrated in FIG. 3, at a ratio of one out of every four pixels Pix. The demosaicing processor 12 calculates a pixel value at a position not provided with the pixel Pix that can detect light of 25 red (R) through interpolation operation to generate a red-color image. The interpolation operation is performed based on a pixel value in the pixel Pix that can detect light of red (R). Similarly, the pixel Pix that can detect light of green (G) is provided, for example, as illustrated in FIG. 3, at a ratio of one out of every two pixels Pix. The demosaicing processor 12 calculates a pixel value at a position not provided with the pixel Pix that can detect light 30 of green (G) through interpolation operation to generate a green-color image. The interpolation operation is performed based on a pixel value in the pixel Pix that can detect light of green (G). The pixel Pix that can detect light of blue (B) is provided, for example, as illustrated in FIG. 3, at a ratio of one out of every four pixels Pix. The demosaicing processor 12 calculates a pixel value at a position not provided with the pixel Pix that can detect light of blue (B) through interpolation operation to generate a blue-color image. The interpolation operation is performed based on a pixel value in the pixel Pix that can detect light of blue (B). In this manner, the demosaicing processor 12 performs demosaicing based on the left image supplied from the left camera 11L to generate a left image PL including the red-color image, the green-color image, and the blue-color image. The demosaicing processor 12 performs demosaicing based on the right image supplied from the right camera 11R to generate a right image PR including the red-color image, the green-color image, and the blue-color image.

As described above, the stereo camera 10 generates the left image PL and the right image PR. The left image PL and the right image PR configure a stereo image PIC.

FIG. 4 illustrates one example of the left image PL and the right image PR configuring the stereo image PIC. In this example, another vehicle (proceeding vehicle 8) is traveling in front of the vehicle 9 on a travel path on which the vehicle 9 is traveling. The left camera 11L images the proceeding vehicle 8 to generate the left image PL. The right camera 11R images the proceeding vehicle 8 to generate the right image PR. The left camera 11L and the right camera 11R are disposed so as to be spaced apart by a predetermined distance in the width direction of the vehicle 9. Accordingly, the left image PL and the right image PR have parallax corresponding to the deviation in disposing positions of the left camera 11L and the right camera 11R.

The stereo camera 10 performs an imaging operation at a predetermined frame rate (for example, 60 [fps]) to generate a series of stereo images PIC. Then, the stereo camera 10 supplies image data of the generated series of stereo images PIC to the processing device 20.

The processing device 20 is configured to perform processing based on the left image PL and the right image PR to control the operation of the driving assistance device 1. The processing device 20 is configured with the use of, for example, one or more processors, one or more memories, and the like, and executes a program to perform the processing. The processing device 20 includes a grayscale image generator 21, a filtering processor 22, a parallax image generator 23, a distance image generator 24, and a driving assistance processor 25.

The grayscale image generator 21 is configured to generate a grayscale image relating to the left image PL based on the red-color image, the green-color image, and the blue-color image included in the left image PL. The grayscale image generator 21 is configured to generate a grayscale image relating to the right image PR based on the red-color image, the green-color image, and the blue-color image included in the right image PR.

The filtering processor 22 is configured to perform filtering on each of the grayscale image relating to the left image PL and the grayscale image relating to the right image PR. As described later, the parallax image generator 23 of the processing device 20 performs stereo matching based on the two grayscale images. The two grayscale images are the grayscale image relating to the left image PL and the grayscale image relating to the right image PR that have been subjected to filtering by the filtering processor 22. The filtering processor 22 performs filtering of emphasizing a feature of an object in the two grayscale images in order to enhance the accuracy of stereo matching. However, in a case where the two grayscale images include, for example, a zipper noise described below and this zipper noise is emphasized, the accuracy of the stereo matching may be reduced.

FIG. 5 illustrates an example of the zipper noise. In this example, a noise pattern of the zipper noise has, for example, a pattern that repeats light and shade in a unit of one pixel toward a certain direction (in this example, a horizontal direction). In this example, the noise pattern includes patterns of two rows, but the noise pattern is not limited thereto. Instead, the noise pattern may include a pattern of one row or patterns of three or more rows. Further, in this example, the noise pattern repeats light and shade in a unit of one pixel, but the noise pattern is not limited thereto. Instead, the noise pattern may repeat light and shade in a unit of a small number of pixels such as a unit of two pixels. Further, in this example, the noise pattern is a one-dimensional pattern extending toward a certain direction, but the noise pattern may be a two-dimensional pattern expanding in a vertical direction and a horizontal direction.

When the two grayscale images include such a zipper noise and the zipper noise is emphasized, a mismatch may be caused in the stereo matching. When the mismatch is caused, the accuracy of the stereo matching may be reduced. In view of the above, the filtering processor 22 performs filtering on each of the grayscale image relating to the left image PL and the grayscale image relating to the right image PR so that the feature of the object is emphasized and the zipper noise is not emphasized. For example, the filtering processor 22 performs the filtering by performing convolution operation with the use of a filter pattern PAT described below.

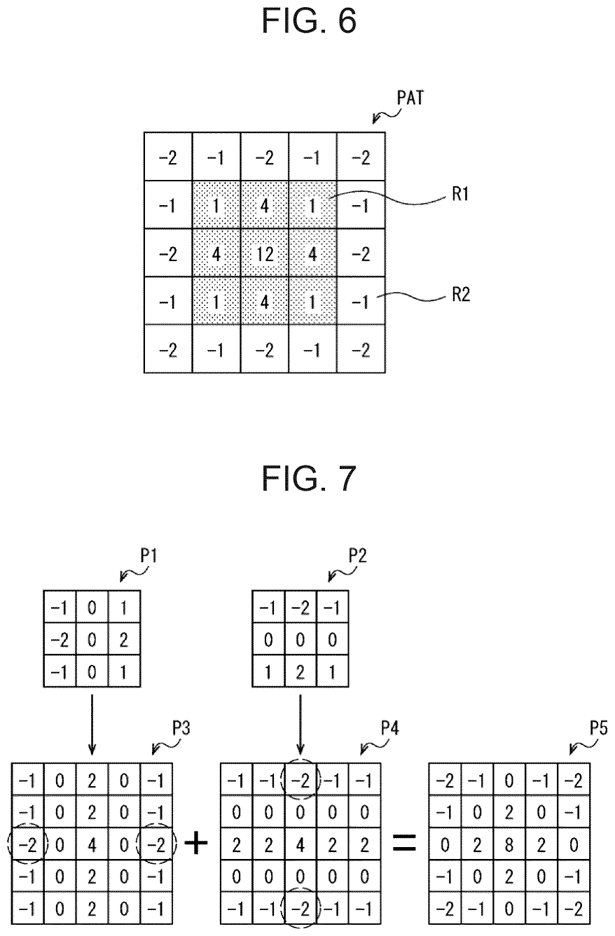

FIG. 6 illustrates one example of the filter pattern PAT. The filter pattern PAT includes twenty-five (=5×5) filter coefficients disposed in five rows and five columns. The filter pattern PAT is divided into a region R1 and a region R2. The region R1 is a region provided in the vicinity of the middle in the filter pattern PAT, and includes nine (=3×3) filter coefficients disposed in three rows and three columns. FIG. 6 illustrates the region R1 with shading. The region R2 is a region provided around the region R1 so as to surround the region R1, and includes sixteen filter coefficients. In this example, the polarity of the nine filter coefficients disposed in the region R1 is the positive polarity, and the polarity of the sixteen filter coefficients disposed in the region R2 is the negative polarity. In the region R1, the filter coefficient having the largest absolute value is disposed at the middle of the region R1. Each of the absolute values of the nine filter coefficients in the region R1 is smaller as separating from the middle of the region R1. The sixteen filter coefficients in the region R2 include eight filter coefficients having a value of “−2” and eight filter coefficients having a value of “−1”. The filter pattern PAT is a pattern having four-fold rotational symmetry. That is, the filter pattern PAT is the same pattern even when being rotated by 90 degrees.

The filtering processor 22 performs filtering on each of the grayscale image relating to the left image PL and the grayscale image relating to the right image PR by performing convolution operation with the use of such a filter pattern PAT.

The parallax image generator 23 is configured to generate a parallax image by performing stereo matching based on the two grayscale images relating to the left image PL and the right image PR that have been subjected to filtering by the filtering processor 22. For example, the parallax image generator 23 performs stereo matching based on the two grayscale images to identify a corresponding point including two image points (a left image point and a right image point) corresponding to each other. The left image point is an image point in the grayscale image relating to the left image PL that has been subjected to filtering. The right image point is an image point in the grayscale image relating to the right image PR that has been subjected to filtering. Then, the parallax image generator 23 calculates a parallax value based on the difference between the position of the left image point and the position of the right image point to generate a parallax image. A plurality of pixel values in the parallax image is a parallax value.

The distance image generator 24 is configured to generate a distance image by converting, based on the parallax image, the pixel values included in the parallax image from the parallax value to a distance value. The distance value indicates a distance from the stereo camera 10 to the object.

The driving assistance processor 25 is configured to perform driving assistance of the vehicle 9. For example, the driving assistance processor 25 recognizes the object based on the left image PL and the right image PR transmitted from the stereo camera 10. Further, for example, the driving assistance processor 25 calculates a speed difference between the vehicle 9 and the proceeding vehicle based on the distance image, and estimates a traveling speed of the proceeding vehicle based on the speed difference and the traveling speed of the vehicle 9. For example, the driving assistance processor 25 controls the operation of the vehicle 9 so as to notify the driver of the processing results. Further, for example, the driving assistance processor 25 controls the operation of the vehicle 9 based on the distance image so that the vehicle 9 travels so as to follow the proceeding vehicle.

Here, the driving assistance device 1 corresponds to one example of “image processing device” in one embodiment of the disclosure. The processing device 20 corresponds to one example of “processing circuit” in the embodiment of the disclosure. The grayscale image relating to the left image PL corresponds to one example of “left image” in the embodiment of the disclosure. The grayscale image relating to the right image PR corresponds to one example of “right image” in the embodiment of the disclosure. The filter pattern PAT corresponds to one example of “filter pattern” in the embodiment of the disclosure. The region R1 corresponds to one example of “first region” in the embodiment of the disclosure. The region R2 corresponds to one example of “second region” in the embodiment of the disclosure. Four second filter coefficients positioned at four corners of the filter pattern PAT correspond to one example of “corner filter coefficients” in the embodiment of the disclosure. Four second filter coefficients positioned at middles of four sides of the filter pattern PAT correspond to one example of “middle filter coefficients” in the embodiment of the disclosure.

### Operation and Actions

Subsequently, the operation and actions of the driving assistance device 1 according to the embodiment are described.

### Overall Operation Outline

First, with reference to FIG. 2, the operation of the driving assistance device 1 is described. The stereo camera 10 images the front side of the vehicle 9 to generate the stereo image PIC including the left image PL and the right image PR. The grayscale image generator 21 generates the grayscale image relating to the left image PL based on the red-color image, the green-color image, and the blue-color image included in the left image PL. The grayscale image generator 21 generates the grayscale image relating to the right image PR based on the red-color image, the green-color image, and the blue-color image included in the right image PR. The filtering processor 22 performs filtering on each of the grayscale image relating to the left image PL and the grayscale image relating to the right image PR by performing convolution operation with the use of the filter pattern PAT. The parallax image generator 23 generates the parallax image by performing stereo matching based on the two grayscale images relating to the left image PL and the right image PR that have been subjected to filtering. The distance image generator 24 generates the distance image by converting, based on the parallax image, the pixel values included in the parallax image from the parallax value into the distance value. The driving assistance processor 25 performs driving assistance of the vehicle 9.

### Detailed Operation

The filtering processor 22 performs filtering on each of the grayscale image relating to the left image PL and the grayscale image relating to the right image PR so as to emphasize the feature of the object and prevent the zipper noise from being emphasized. For example, the filtering processor 22 performs the filtering by performing convolution operation with the use of the filter pattern PAT illustrated in FIG. 6. Hereinafter, a method of creating the filter pattern PAT is described in detail.

FIG. 7 to FIG. 9 illustrate one example of the method of creating the filter pattern PAT. In this example, the filter pattern PAT is created with the use of a Sobel filter and a Gaussian filter. The Sobel filter is a sharpening filter, and is used to emphasize the feature of the object in the image. The Gaussian filter is a smoothing filter, and is used so that the zipper noise is not emphasized.

First, as illustrated in FIG. 7, filter patterns P1, P2 of two Sobel filters are prepared. Each of the filter patterns P1, P2 has nine (=3×3) filter coefficients disposed in three rows and three columns.

In the filter pattern P1, the polarity of the filter coefficient in the left column is the negative polarity, the filter coefficient in the middle column is zero, and the polarity of the filter coefficient in the right column is the positive polarity. The absolute values of the three filter coefficients in the left column and the absolute values of the three filter coefficients in the right column are equal to each other. The filter pattern PI has symmetry in the vertical direction. The filtering using the filter pattern PI described above can emphasize the change in pixel value in the horizontal direction.

In the filter pattern P2, the polarity of the filter coefficient in the upper row is the negative polarity, the filter coefficient in the middle row is zero, and the polarity of the filter coefficient in the lower row is the positive polarity. The absolute values of the three filter coefficients in the upper row and the absolute values of the three filter coefficients in the lower row are equal to each other. The filter pattern P2 has symmetry in the horizontal direction. The filtering using the filter pattern P2 described above can emphasize the change in pixel value in the vertical direction.

Next, the filter pattern PI is transformed so that a filter pattern P3 is created. The filter pattern P3 includes twenty-five (=5×5) filter coefficients disposed in five rows and five columns. In the filter pattern P3, the polarity of the filter coefficients in the leftmost column is the negative polarity, the filter coefficients in the second column from the left are zero, the polarity of the filter coefficients in the middle column is the positive polarity, the filter coefficients in the second column from the right are zero, and the polarity of the filter coefficients in the rightmost column is the negative polarity. The five filter coefficients in the leftmost column and the five filter coefficients in the rightmost column are equal to each other. The filter pattern P3 has symmetry in each of the vertical direction and the horizontal direction. The filtering using the filter pattern P3 described above can emphasize the change in pixel value in the horizontal direction.

Similarly, the filter pattern P2 is transformed so that a filter pattern P4 is created. The filter pattern P4 includes twenty-five (=5×5) filter coefficients disposed in five rows and five columns. In the filter pattern P4, the polarity of the filter coefficients in the uppermost row is the negative polarity, the filter coefficients in the second row from the top are zero, the polarity of the filter coefficients in the middle row is the positive polarity, the filter coefficients in the second row from the bottom are zero, and the polarity of the filter coefficients in the lowermost row is the negative polarity. The five filter coefficients in the uppermost row and the five filter coefficients in the lowermost row are equal to each other. The filter pattern P4 has symmetry in each of the vertical direction and the horizontal direction. The filter pattern P4 has a pattern obtained by rotating the filter pattern P3 by 90 degrees. The filtering using the filter pattern P4 described above can emphasize the change in pixel value in the vertical direction.

As described later, finally, a filter pattern P6 based on the filter patterns P3, P4 and a filter pattern P7 having a pattern of three rows and three columns are added to each other so that the filter pattern PAT is generated. In consideration of the fact that the filter pattern P7 is a pattern having three rows and three columns, the filter patterns P3, P4 are set to patterns each having five rows and five columns to be larger than the filter pattern P7.

Next, the filter pattern P3 and the filter pattern P4 are added to each other so that a filter pattern P5 is created. The filter pattern P4 is the same as a pattern obtained by rotating the filter pattern P3 by 90 degrees, and hence the filter pattern P5 obtained by adding the patterns is a pattern having four-fold rotational symmetry. That is, the filter pattern P5 is the same pattern even when being rotated by 90 degrees. In the filter pattern P5, the values of the nine (=3×3) filter coefficients disposed in three rows and three columns in the vicinity of the middle are values having the positive polarity or zero. In the filter pattern P5, the values of the sixteen filter coefficients disposed at positions surrounding the nine filter coefficients are values having the negative polarity or zero.

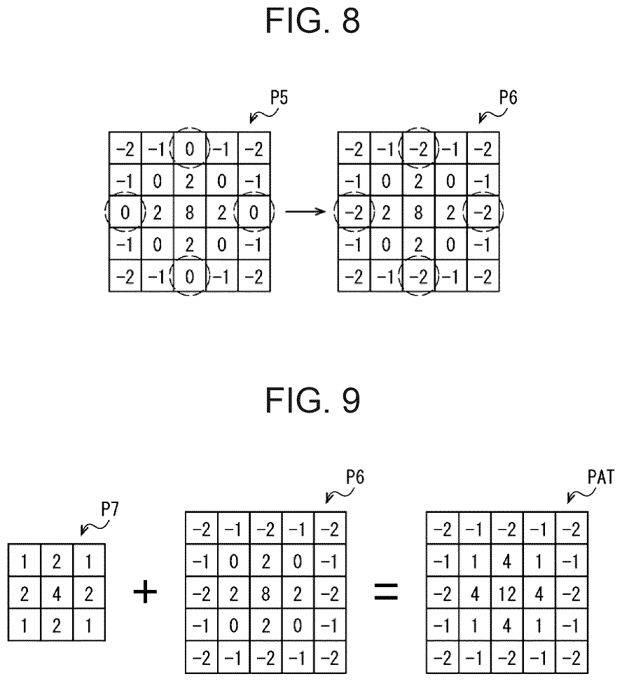

In FIG. 8, as indicated by the chain lines, in the filter pattern P5, the filter coefficient at the middle in the leftmost column, the filter coefficient at the middle in the rightmost column, the filter coefficient at the middle in the uppermost row, and the filter coefficient at the middle in the lowermost row are zero. In this case, it is difficult to emphasize the change in pixel value in the horizontal direction, and similarly difficult to emphasize the change in pixel value in the vertical direction. Thus, the filter pattern P6 is created by adjusting the values of those four filter coefficients in the filter pattern P5. This example uses, as indicated by the chain lines in FIG. 7, the filter coefficient at the middle in the leftmost column and the filter coefficient at the middle in the rightmost column in the filter pattern P3 and the filter coefficient at the middle in the uppermost row and the filter coefficient at the middle in the lowermost row in the filter pattern P4. In this manner, in the filter pattern P6, the four filter coefficients are set to “−2”. The filtering using the filter pattern P6 described above can emphasize the change in pixel value in the vertical direction and the horizontal direction.

Next, as illustrated in FIG. 9, the filter pattern P7 being a Gaussian filter is prepared. The filter pattern P7 includes nine (=3×3) filter coefficients disposed in three rows and three columns. The polarity of the nine filter coefficients is the positive polarity. Out of the nine filter coefficients, the filter coefficient disposed at the middle is the largest. The nine filter coefficients are smaller as separating from the middle. The filter pattern P7 is a pattern having four-fold rotational symmetry. That is, the filter pattern P7 is the same pattern even when being rotated by 90 degrees.

The Gaussian filter is used to prevent the zipper noise from being emphasized. As illustrated in FIG. 5, in this example, the noise pattern of the zipper noise repeats light and shade in a unit of one pixel. Thus, in this example, the filter pattern P7 may be a small pattern having three rows and three columns.

Then, as illustrated in FIG. 9, the filter pattern P6 and the filter pattern P7 are added to each other so that the filter pattern PAT illustrated in FIG. 6 is created. For example, the nine (=3×3) filter coefficients in the filter pattern P7 are added to the nine (=3×3) filter coefficients disposed in three rows and three columns in the vicinity of the middle in the filter pattern P6 so that the filter pattern PAT is created. The filter pattern PAT has both of the feature of the filter pattern P6 and the feature of the filter pattern P7. Thus, the filtering using the filter pattern PAT described above can emphasize the feature of the object and prevent the zipper noise from being emphasized.

### Processing Example of Filtering

Next, description is given of a processing example of the filtering using the filter pattern PAT.

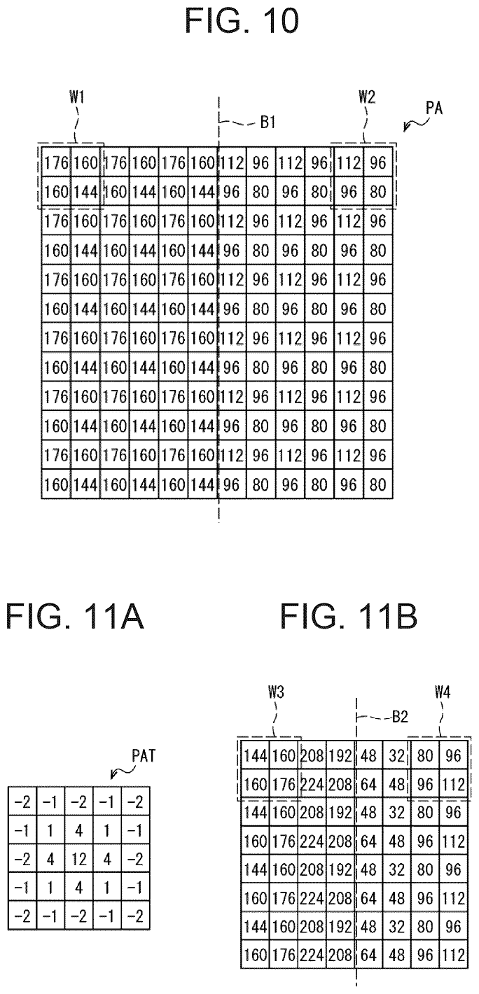

FIG. 10 illustrates one example of a processing target image PA to be subjected to filtering. The processing target image PA corresponds to the grayscale image to be supplied to the filtering processor 22. The processing target image PA is divided into, across a boundary line B1, a left half having large pixel values and a right half having small pixel values. In the left half, a partial image W1 including four pixel values is repeatedly disposed, and, in the right half, a partial image W2 including four pixel values is repeatedly disposed.

In the partial image WI in the left half, the upper-left pixel value is “176”, the lower-left pixel value is “160”, the upper-right pixel value is “160”, and the lower-right pixel value is “144”. In the partial image W1, the difference between two pixel values arranged in the vertical direction is “16”, and the difference between two pixel values arranged in the horizontal direction is “16”. In the partial image W2 in the right half, the upper-left pixel value is “112”, the lower-left pixel value is “96”, the upper-right pixel value is “96”, and the lower-right pixel value is “80”. In the partial image W2, the difference between two pixel values arranged in the vertical direction is “16”, and the difference between two pixel values arranged in the horizontal direction is “16”. In the left half, the partial image W1 is repeatedly disposed, and, in the right half, the partial image W2 is repeatedly disposed. Thus, a two-dimensional zipper noise is configured. Further, in this example, the difference between two right and left pixel values across the boundary line B1 is “48”.

FIG. 11A and FIG. 11B illustrate one example of filtering using the filter pattern PAT. FIG. 11A illustrates the filter pattern PAT. FIG. 11B illustrates an image generated by filtering. It is to be noted that the filter pattern PAT has a scale factor of “8”. The scale factor of the filter pattern PAT is an absolute value of a sum of twenty-five filter coefficients in the filter pattern PAT. In the filtering, the scale of the pixel value is adjusted based on the scale factor.

The image generated by filtering is divided into, as illustrated in FIG. 11B, similarly to the processing target image PA, a left half having large pixel values and a right half having small pixel values across a boundary line B2. In this example, the difference between two right and left pixel values across the boundary line B2 is “144”, and is larger than the difference of “48” between two right and left pixel values across the boundary line B1 in the processing target image PA illustrated in FIG. 10. As described above, in the vicinity of the boundary line B2 in the image generated by filtering, the pixel value drastically changes in the horizontal direction. That is, in this filtering, an edge is emphasized. Thus, in this filtering, it is expected to emphasize the feature of the object.

For example, in a partial image W3 in the left half, the upper-left pixel value is “144”, the lower-left pixel value is “160”, the upper-right pixel value is “160”, and the lower-right pixel value is “176”. In the partial image W3, the difference between two pixel values arranged in the vertical direction is “16”, and the difference between two pixel values arranged in the horizontal direction is “16”. Those values are the same as the difference of “16” between two pixel values arranged in the vertical direction and the difference of “16” between two pixel values arranged in the horizontal direction in the partial image W1 of the processing target image PA illustrated in FIG. 10. Similarly, in a partial image W4 in the right half, the upper-left pixel value is “80”, the lower-left pixel value is “96”, the upper-right pixel value is “96”, and the lower-right pixel value is “112”. In the partial image W4, the difference between two pixel values arranged in the vertical direction is “16”, and the difference between two pixel values arranged in the horizontal direction is “16”. Those values are the same as the difference of “16” between two pixel values arranged in the vertical direction and the difference of “16” between two pixel values arranged in the horizontal direction in the partial image W2 of the processing target image PA illustrated in FIG. 10. Thus, in this filtering, the zipper noise is not emphasized.

As described above, the filtering using the filter pattern PAT can emphasize the feature of the object and prevent the zipper noise from being emphasized.

Next, as reference examples, description is given of one example of filtering in a case where a Gaussian filter being a smoothing filter is used and one example of filtering in a case where an unsharp filter being a sharpening filter is used.

### Reference Example E1

Description is given of a case where filtering is performed on the processing target image PA illustrated in FIG. 10 with the use of the Gaussian filter being a smoothing filter.

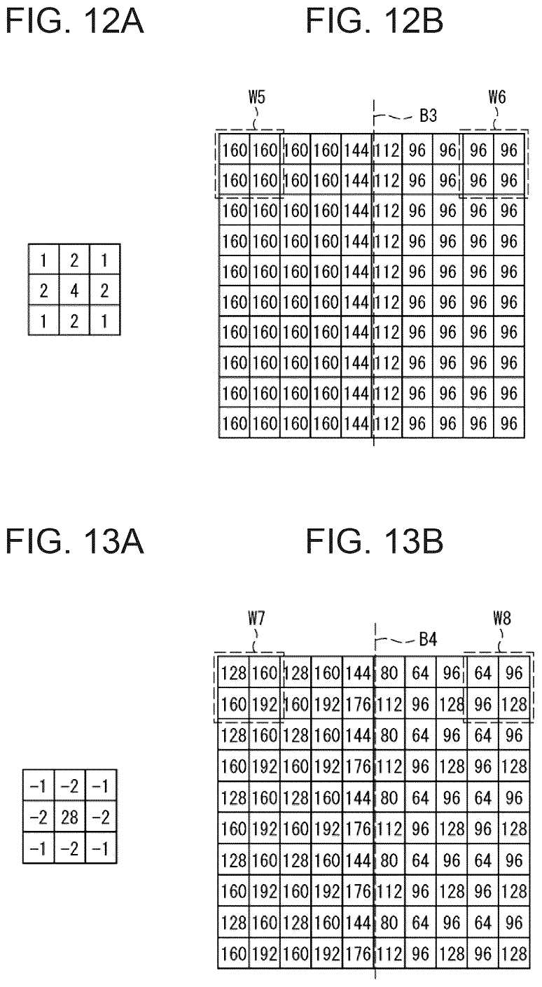

FIG. 12A and FIG. 12B illustrate one example of filtering in a case where a Gaussian filter is used. FIG. 12A illustrates a filter pattern. FIG. 12B illustrates an image generated by filtering. It is to be noted that this filter pattern has a scale factor of “16”.

The image generated by filtering is divided into, similarly to the processing target image PA, a left half having large pixel values and a right half having small pixel values across a boundary line B3. For example, in a partial image W5 in the left half, all of the four pixel values are “160”. Similarly, in a partial image W6 in the right half, all of the four pixel values are “96”. That is, in this example, since the Gaussian filter being a smoothing filter is used, the pixel values are smoothened. Thus, in this filtering, the zipper noise is reduced.

However, in this example, the difference between two right and left pixel values across the boundary line B3 is “32”, and is smaller than the difference of “48” between two right and left pixel values across the boundary line B1 in the processing target image PA illustrated in FIG. 10. As illustrated in FIG. 12B, in the vicinity of the boundary line B3, the pixel value gently changes in the horizontal direction. That is, in this filtering, the edge is gentle. In this case, in this filtering, the feature of the object is not emphasized, resulting in that the accuracy of the stereo matching may be reduced.

### Reference Example E2

Description is given of a case where filtering is performed on the processing target image PA illustrated in FIG. 10 with the use of an unsharp filter being a sharpening filter.

FIG. 13A and FIG. 13B illustrate one example of filtering in the case of using the unsharp filter. FIG. 13A illustrates a filter pattern. FIG. 13B illustrates an image generated by filtering. It is to be noted that this filter pattern has a scale factor of “16”.

The image generated by filtering is divided into, similarly to the processing target image PA, a left half having large pixel values and a right half having small pixel values across a boundary line B4. In this example, the difference between two right and left pixel values across the boundary line B4 is “64”, and is larger than the difference of “48” between two right and left pixel values across the boundary line B1 in the processing target image PA. That is, in this filtering, the edge is emphasized. Thus, in this filtering, it is expected to emphasize the feature of the object.

However, in a partial image W7 in the left half, the upper-left pixel value is “128”, the lower-left pixel value is “160”, the upper-right pixel value is “160”, and the lower-right pixel value is “192”. In the partial image W7, the difference between two pixel values arranged in the vertical direction is “32”, and the difference between two pixel values arranged in the horizontal direction is “32”. Those values are twice as large as the difference of “16” between two pixel values arranged in the vertical direction and the difference of “16” between two pixel values arranged in the horizontal direction in the partial image W1 of the processing target image PA illustrated in FIG. 10. Similarly, in a partial image W8 in the right half, the upper-left pixel value is “64”, the lower-left pixel value is “96”, the upper-right pixel value is “96”, and the lower-right pixel value is “128”. In the partial image W8, the difference between two pixel values arranged in the vertical direction is “32”, and the difference between two pixel values arranged in the horizontal direction is “32”. Those values are twice as large as the difference of “16” between two pixel values arranged in the vertical direction and the difference of “16” between two pixel values arranged in the horizontal direction in the partial image W2 of the processing target image PA illustrated in FIG. 10. As described above, in this filtering, the zipper noise is also emphasized. When the zipper noise is emphasized as described above, the accuracy of the stereo matching may be reduced.

Meanwhile, in the driving assistance device 1 in this embodiment, the filtering is performed with the use of the filter pattern PAT illustrated in FIG. 6, and hence the edge can be emphasized and the zipper noise can be prevented from being emphasized. In this manner, in the driving assistance device 1, the feature of the object can be emphasized, and hence the accuracy of the stereo matching can be enhanced. Further, in the driving assistance device 1, the zipper noise can be prevented from being emphasized, and hence the reduction in accuracy of the stereo matching due to the zipper noise can be prevented. As a result, in the driving assistance device 1, the accuracy of the parallax image and the distance image can be enhanced.

### Estimation Accuracy of Traveling Speed

For example, the driving assistance processor 25 calculates the speed difference between the vehicle 9 and the proceeding vehicle based on the distance image, and estimates the traveling speed of the proceeding vehicle based on the speed difference and the traveling speed of the vehicle 9.

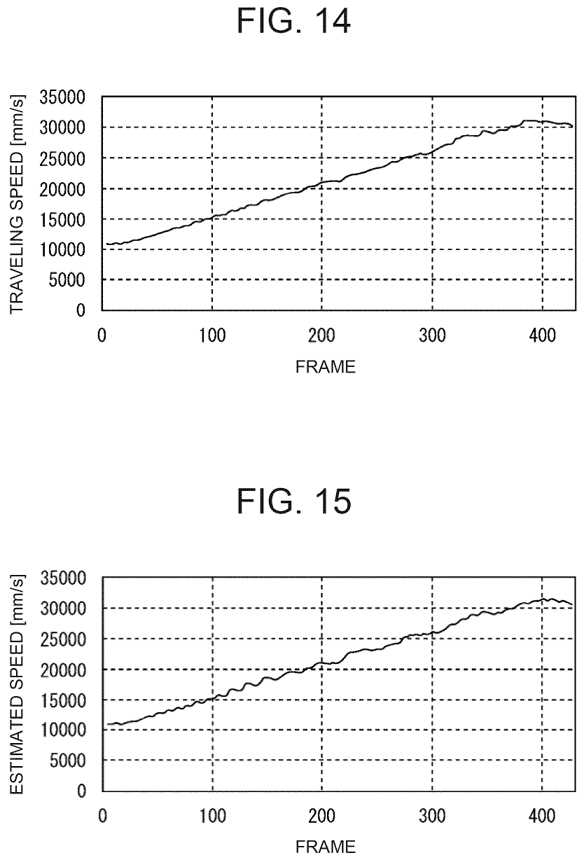

FIG. 14 illustrates one example of the traveling speed of the proceeding vehicle estimated by the driving assistance processor 25. The horizontal axis represents the ordinal number of the frame, and the vertical axis represents the estimated value of the traveling speed of the proceeding vehicle. In this example, the estimated value of the traveling speed rises relatively smoothly as the time elapses.

FIG. 15 illustrates one example of the estimated value of the traveling speed of the proceeding vehicle according to a reference example. In this example, instead of performing filtering with the use of the filter pattern PAT, filtering with the use of the sharpening filter is performed. In this case, the estimated value of the traveling speed has fluctuations.

When the filtering is performed with the use of the filter pattern PAT (FIG. 14), as compared with the case where the filtering is performed with the use of the sharpening filter (FIG. 15), the fluctuations of the estimated value of the traveling speed can be reduced. That is, in the driving assistance device 1, the filtering is performed with the use of the filter pattern PAT, and thus the reduction in accuracy of the stereo matching due to the zipper noise can be suppressed, and the reduction in accuracy of the distance image can be suppressed. As a result, the estimation accuracy of the traveling speed can be enhanced.

As described above, the driving assistance device 1 can perform filtering on each of the left image (the grayscale image relating to the left image PL) and the right image (the grayscale image relating to the right image PR) with the use of a predetermined filter pattern PAT. Further, the driving assistance device 1 includes a processing circuit (the processing device 20) capable of generating a distance image by performing stereo matching based on the left image and the right image that have been subjected to filtering. The filter pattern PAT includes a plurality of first filter coefficients provided in the first region (region R1) and having values of a first polarity, and a plurality of second filter coefficients provided in a second region (the region R2) disposed around the first region (the region R1) and having values of a second polarity different from the first polarity. One of the first filter coefficients having the largest absolute value is provided at the middle of the first region. The second filter coefficients include two or more filter coefficients having values different from each other. The filter pattern is a pattern having four-fold rotational symmetry. In this manner, in the driving assistance device 1, in the left image and the right image, the feature of the object can be emphasized, and thus the accuracy of the stereo matching can be enhanced. Further, in the driving assistance device 1, the zipper noise is not emphasized, and thus the reduction in accuracy of the stereo matching due to the zipper noise can be suppressed.

In the driving assistance device 1, the processing circuit (the processing device 20) is capable of performing the filtering with the use of the single filter pattern PAT. In this manner, the amount of calculation can be reduced in the processing device 20, and hence the processing can be performed even when the processing device 20 is applied to a device that does not have abundant processing resources, such as an embedded device. For example, when filtering using a filter pattern of a sharpening filter and filtering using a filter pattern of a smoothing filter are separately performed, the amount of processing increases. In this case, for example, it is difficult to perform processing in a device that does not have abundant processing resources. In the driving assistance device 1, the filtering is performed with the use of the filter pattern PAT including the feature of the sharpening filter and the feature of the smoothing filter. As described above, the filtering is performed with the use of the single filter pattern PAT, and hence the filtering is performed once. Thus, the amount of processing can be reduced. As a result, for example, processing can be performed in a device that does not have abundant processing resources.

In the driving assistance device 1, each of absolute values of the first filter coefficients in the first region (region R1) is smaller as separating from the middle of the first region (region R1). In this manner, the filter pattern PAT includes the feature of the smoothing filter, and hence the zipper noise can be prevented from being emphasized. As a result, the reduction in accuracy of the stereo matching due to the zipper noise can be suppressed.

In the driving assistance device 1, one or more of the left image (the grayscale image relating to the left image PL) and the right image (the grayscale image relating to the right image PR) include a noise pattern that repeats light and shade in a unit of one or more pixel values in a predetermined direction. In the driving assistance device 1, as described above, even when the grayscale image includes such a noise pattern, the noise of the noise pattern can be prevented from being emphasized, and hence the reduction in accuracy of the stereo matching can be suppressed.

In the driving assistance device 1, the left image (the grayscale image relating to the left image PL) and the right image (the grayscale image relating to the right image PR) can be generated by demosaicing. In the demosaicing, the pixel value is calculated by interpolation operation, and hence the zipper noise may be caused. In the driving assistance device 1, even in this case, the zipper noise can be prevented from being emphasized, and hence the reduction in accuracy of the stereo matching due to the zipper noise can be suppressed.

### Effects

As described above, in this embodiment, the processing circuit capable of performing filtering on each of the left image and the right image with the use of the predetermined filter pattern PAT and capable of generating a distance image by performing stereo matching based on the left image and the right image that have been subjected to filtering is included. The filter pattern includes a plurality of first filter coefficients provided in a first region and having values of a first polarity, and a plurality of second filter coefficients provided in a second region disposed around the first region and having values of a second polarity different from the first polarity. One of the first filter coefficients having the largest absolute value is provided at the middle of the first region. The second filter coefficients include two or more filter coefficients having values different from each other. The filter pattern is a pattern having four-fold rotational symmetry. In this manner, the reduction in accuracy of the stereo matching can be suppressed.

In this embodiment, the processing circuit can perform the filtering with the use of the single filter pattern, and hence the processing can be performed in a device that does not have abundant processing resources.

In this embodiment, each of absolute values of the first filter coefficients in the first region is smaller as separating from the middle of the first region, and hence the reduction in accuracy of the stereo matching can be suppressed.

In the driving assistance device 1, one or more of the left image and the right image include a noise pattern that repeats light and shade in a unit of one or more pixel values in a predetermined direction, and hence the reduction in accuracy of the stereo matching can be suppressed.

In the driving assistance device 1, the left image and the right image can be generated by demosaicing. In this case, the zipper noise may be caused in the left image and the right image, but the reduction in accuracy of the stereo matching can be suppressed even in this case.

An exemplary embodiment of the disclosure has been described above with reference to the accompanying drawings, but the disclosure may not be limited to the embodiment. Those skilled in the art will understand that various modifications and changes can be made thereto without departing from the scope defined by the disclosure. The disclosure may be intended to include such various modifications and changes to the extent that they fall within the scope of the embodiment and equivalents thereof.

For example, in the above-mentioned embodiment, as illustrated in FIG. 6, twenty-five filter coefficients are set, but the disclosure is not limited thereto, and the twenty-five filter coefficients can be changed as appropriate.

For example, in the above-mentioned embodiment, the filter pattern PAT includes twenty-five (=5×5) filter coefficients disposed in five rows and five columns as illustrated in FIG. 6, but the disclosure is not limited thereto. The filter pattern may include, for example, forty-nine (=7×7) filter coefficients disposed in seven rows and seven columns. In this case, the region R1 may include, for example, nine (=3×3) filter coefficients disposed in three rows and three columns, or twenty-five (=5×5) filter coefficients disposed in five rows and five columns.

The above-mentioned effects are merely examples, and the effects of the disclosure are not limited to the effects described above. Thus, other effects may be obtained with respect to the disclosure.

Moreover, the disclosure may take the following aspects.

(1) An image processing device including a processing circuit configured to perform filtering on each of a left image and a right image with use of a filter pattern set in advance, and generate a distance image by performing stereo matching based on the left image and the right image that have been subjected to the filtering. In the image processing device, the filter pattern includes a plurality of first filter coefficients provided in a first region and a plurality of second filter coefficients provided in a second region disposed around the first region, the first filter coefficients each having a value of a first polarity, the second filter coefficients each having a value of a second polarity different from the first polarity, one of the first filter coefficients having a largest absolute value is provided at a middle of the first region, the second filter coefficients include two or more filter coefficients having respective values different from each other, and the filter pattern is a pattern having four-fold rotational symmetry.

(2) In the image processing device according to Item (1), the processing circuit is configured to perform the filtering with the use of the filter pattern that is single filter pattern.

(3) In the image processing device according to Item (1) or (2), each of absolute values of the first filter coefficients in the first region is smaller as separating from the middle of the first region.

(4) In the image processing device according to any one of Items (1) to (3), one or both of the left image and the right image include a noise pattern that repeats light and shade in a unit of one or more pixel values in a predetermined direction.

(5) In the image processing device according to any one of Items (1) to (4), the left image and the right image are generated by demosaicing.

The processing device 20 illustrated in FIG. 2 can be implemented by a circuit including at least one semiconductor integrated circuit such as at least one processor (for example, a central processing unit (CPU)), at least one application specific integrated circuit (ASIC), and/or at least one field programmable gate array (FPGA). The at least one processor can be configured to execute all or a part of functions of the processing device 20 illustrated in FIG. 2 by reading instructions from at least one computer readable non-transitory tangible medium. Such a medium may take many forms, including any type of magnetic medium such as a hard disk, any type of optical medium such as a CD or a DVD, and any type of semiconductor memory (that is, a semiconductor circuit) such as a volatile memory or a non-volatile memory, but the disclosure is not limited thereto. The volatile memory may include a DRAM and an SRAM. The non-volatile memory may include a ROM and an NVRAM. The ASIC is an integrated circuit (IC) customized to execute all or a part of the functions of the processing device 20 illustrated in FIG. 2. The FPGA is an integrated circuit designed to be configured after manufacturing in order to execute all or a part of the functions of the processing device 20 illustrated in FIG. 2.

What is claimed is:

1. An image processing device comprising a processing circuit configured to perform filtering on each of a left image and a right image with use of a filter pattern set in advance, and generate a distance image by performing stereo matching based on the left image and the right image that have been subjected to the filtering, wherein:
the filter pattern comprises a plurality of first filter coefficients provided in a first region and a plurality of second filter coefficients provided in a second region disposed around the first region, the first filter coefficients each having a value of a first polarity, the second filter coefficients each having a value of a second polarity different from the first polarity;
one of the first filter coefficients having a largest absolute value is provided at a middle of the first region;
the second filter coefficients comprise two or more filter coefficients having respective values different from each other;
the second filter coefficients comprise four corner filter coefficients positioned at four corners of the filter pattern, and each of the corner filter coefficients has an absolute value larger than an absolute value of an adjacent filter coefficient in the filter pattern; and
the filter pattern is a pattern having four-fold rotational symmetry.

2. An image processing device comprising a processing circuit configured to perform filtering on each of a left image and a right image with use of a filter pattern set in advance, and generate a distance image by performing stereo matching based on the left image and the right image that have been subjected to the filtering, wherein:
the filter pattern comprises a plurality of first filter coefficients provided in a first region and a plurality of second filter coefficients provided in a second region disposed around the first region, the first filter coefficients each having a value of a first polarity, the second filter coefficients each having a value of a second polarity different from the first polarity;
one of the first filter coefficients having a largest absolute value is provided at a middle of the first region;
the second filter coefficients comprise two or more filter coefficients having respective values different from each other;
the second filter coefficients comprise four middle filter coefficients positioned at middles of four sides of the filter pattern, and each of the middle filter coefficients has an absolute value larger than an absolute value of an adjacent second filter coefficient in the filter pattern; and
the filter pattern is a pattern having four-fold rotational symmetry.

3. The image processing device according to claim 1, wherein the processing circuit is configured to perform the filtering with use of the filter pattern that is a single filter pattern.

4. The image processing device according to claim 2, wherein the processing circuit is configured to perform the filtering with use of the filter pattern that is a single filter pattern.

5. The image processing device according to claim 1, wherein each of absolute values of the first filter coefficients in the first region is smaller as separating from the middle of the first region.

6. The image processing device according to claim 2, wherein each of absolute values of the first filter coefficients in the first region is smaller as separating from the middle of the first region.

7. The image processing device according to claim 1, wherein one or both of the left image and the right image comprise a noise pattern that repeats light and shade in a unit of one or more pixel values in a predetermined direction.

8. The image processing device according to claim 2, wherein one or both of the left image and the right image comprise a noise pattern that repeats light and shade in a unit of one or more pixel values in a predetermined direction.

9. The image processing device according to claim 1, wherein the left image and the right image are generated by demosaicing.

10. The image processing device according to claim 2, wherein the left image and the right image are generated by demosaicing.
